(19) United States
(12) Patent Application Publication
(10) Pub. No.: US 2009/0102414 A1
(43) Pub. Date: Apr. 23, 2009

(54) Solar-Powered Charger

(76) Inventor: David Fowler, Dorset (GB)

Correspondence Address: HELLER EHRMAN LLP, 4350 LA JOLLA VILLAGE DRIVE #700, 7TH FLOOR, SAN DIEGO, CA, 92122, US

(21) Appl. No.: 12/188,911

(22) Filed: Aug. 8, 2008

Related U.S. Application Data
(60) Provisional application No. 60/954,780, filed on Aug. 8, 2007.

(51) Int. Cl. H02J 7/00

(52) U.S. Cl. 320/101

(57) ABSTRACT

A solar-powered charger includes a solar collector configured to generate electrical energy when exposed to light, a battery coupled to the solar collector configured to receive and store the electrical energy, a connector coupled to the solar collector and the battery to provide a pathway for discharging the electrical energy to an external device and a casing configured to retain the solar collector, the battery and the connector, comprising an integral clip configured to attach the solar-power charger to a plurality of objects.

This application claims the benefit of the filing date of U.S. Provisional Application No. 60/954,780, filed on Aug. 8, 2007, which is incorporated herein by reference in its entirety.

### BACKGROUND

Solar powered chargers conveniently provide power in any location. Locations where solar powered chargers are particularly useful include rural and mountainous locations distant from existing power distribution points. Persons wishing power for lighting, communication or portable electronic equipment while hiking, camping, or traveling to remote destinations will find solar powered chargers useful. However, solar powered chargers are often not suited to the conditions of travel or transportation. Even within an urban area, it may be difficult to use or protect a solar powered charger during travel or transport, as the charger may not be able to be exposed to the sun during those periods. Accordingly, there is need in the art for solar powered chargers suitable for use while hiking, camping, traveling or even walking about town.

### SUMMARY

A solar powered charger according to one aspect of the present invention includes a solar collector element configured to provide electrical power when exposed to light, such as sunlight, artificial light or other light; a connector element providing a pathway for electrical energy generated by the solar collector to be discharged; and a casing having a clip configured for attaching the solar powered charger to a variety of objects. In preferred embodiments, the casing is a sturdy casing able to withstand weight or shock so that the solar powered charger is able to withstand being placed under heavy objects, or to withstand contact with hard or sharp objects (e.g., rocks or metal objects). In preferred embodiments, the clip may be a carabiner clip, having a hinged portion allowing ready insertion of a rope, strap, band, belt, or other element to which the solar charger may be attached. Attachment of a solar powered charger via a clip, such as a carabiner clip, allows exposure of the charger to the sun or to ambient light of any kind during transport (e.g., a solar powered charger clipped to a pack may be charged while the user carries the pack and charger during hiking or other form of transport). The combination of a solar powered charger with attachment means such as a carabiner clip provides flexibility of use and the advantages of secure attachment to an object or surface while allowing exposure of the solar charging elements to light, such as sunlight, while transporting the charger, and in addition allows the charger to be easily attached to a surface or an object for extended charging in the sun.

In some embodiments of the present invention, a connector element is adaptable to mate with a plurality of complementary connectors, so that, for example, electrically powered devices from a plurality of manufacturers or devices of different designs and functions may be connected to the solar powered charger. In some embodiments, a battery within a solar powered charger according to one aspect of the present invention may be rechargeable by external power supply (e.g., a wall-outlet-powered charger or external battery, via, e.g., a cable, USB connector, or other connector). A connector may be attached to, or may include, a wire or cable element, preferably a flexible wire or cable, allowing ease of connection to other connectors, cables, or devices. In some embodiments, a wire or cable element is waterproof. A solar powered charger having features of the invention may include a battery or other electrical storage element configured to retain and store electrical energy for discharge at a later time. A solar powered charger according to one aspect of the present invention is preferably housed in a sturdy casing providing support for the solar collector element while allowing ready exposure of the solar collector element to light. In some embodiments, a solar collector may be covered with a transparent or translucent cover or coating to provide additional protection and strength.

A solar powered charger according to one aspect of the present invention includes a clip, such as a carabiner, and provides portable and flexible electrical power suitable for powering lights, global positioning service (GPS) devices, radios, telephones, computers, personal assistant devices, electronic music players, and other personal, portable, or other electronic devices in any location.

### BRIEF DESCRIPTION OF THE FIGURES

The present invention is illustrated by way of example and not by way of limitation in the figures of the accompanying drawings, in which:

FIG. 1 is a first plan view of a solar-powered charger according to one embodiment of the invention;

FIG. 2 is a second plan view of a solar-powered charger according to one embodiment of the invention;

FIG. 3 is a first side elevation view of a solar-powered charger according to one embodiment of the invention;

FIG. 4 is a second side elevation view of a solar-powered charger according to one embodiment of the invention;

FIG. 5 is a first elevation perspective view of a solar-powered charger according to one embodiment of the invention;

FIG. 6 is a second elevation perspective view of a solar-powered charger according to one embodiment of the invention; and

FIG. 7 is a perspective view of a solar powered charger according to one embodiment of the invention.

### DETAILED DESCRIPTION

In the following description, numerous specific details are set forth such as examples of specific materials, methods, components, etc. in order to provide a thorough understanding of the present invention. It will be apparent, however, to one skilled in the art that these specific details need not be employed to practice the present invention. In other instances, well-known materials or methods have not been described in detail in order to avoid unnecessarily obscuring the present invention.

A solar powered charger according to one embodiment of the invention may include a solar panel or solar collector having a power output of about 0.1 Watts to about 5 Watts, or may have a power output of between about 0.5 Watts and about 1 Watt, or may provide other amounts of power. In a particular embodiment, the solar collector may provide up to about 0.6 Watts of power.

It will be understood that the term “solar charger” or other reference to “solar” indicates an element that, when exposed to light of any kind and from any source, including but not limited to sunlight, provides electrical energy. An element that provides electrical power upon exposure to light may be termed a photoelectric element. Suitable photoelectric elements include selenium metal photoelectric elements, silicon semiconductor photoelectric elements, amorphous silicon photoelectric elements, amorphous-microcrystalline silicon stacked photoelectric elements, crystalline silicon photoelectric elements, polycrystalline silicon photoelectric elements, copper indium selenide photoelectric elements, compound semiconductor photoelectric elements, and the like.

In one embodiment, a solar powered charger having a photoelectric element may include a photoelectric element encapsulated in plastic, polymer, ceramic, or other material, such as, e.g., polycarbonate, to provide a photoelectric element molded into a casing to provide a fully encapsulated, waterproof and/or gas impermeable, device with integrated photoelectric element.

A solar powered charger according to one embodiment of the invention may include a rechargeable battery configured to collect and store the electrical power output by the collector. Any suitable rechargeable battery may be used, including nickel-cadmium, lithium ion, and other batteries, and any suitable combination of batteries may be used. For example, a rechargeable lithium battery may be used. In some embodiments, a suitable rechargeable lithium battery may be rated at 3.7 V and 1000 mAh (milliamp hours).

The collector output and battery output may be configured in parallel, may be configured in series, and may be configured in an adjustable manner in which a switch or other element determines the source of output power (whether directly from the solar collector, directly from the battery, or from both). Diodes, switches, or other elements may be included in the output circuit to insure proper power output.

In preferred embodiments, a connector is in electrical contact with the power output element (including the solar collector, battery, and control circuitry), includes a flexible cable, and is configured to accept a plurality of connector ends so as to mate with various types of external equipment to power that external equipment.

External equipment which may be powered by a solar powered charger having features of the invention include game devices, including game consoles; GPS devices, lights, including flashlights and lamps, including headlamps (e.g., lights that may be worn on the head or attached to a hat or headband); music players (e.g., MP3 players, iPod® devices, etc.); headphones; telephones; cameras; a personal data assistant (PDA) devices; mobile messaging devices; computers; clocks; and other devices. Connectors include USB connectors, microphone jacks, connectors for devices from a variety of different manufacturers or models (e.g., Nokia; Motorola; Samsung; Sony Ericksson; Blackberry; etc.).

Embodiments of the invention include a sturdy case made of metal, plastic, composite, polymer, or other suitable material. Suitable materials include, for example, metal, such as, for example, magnesium, aluminum, steel (including stainless steel),;and other metals; plastic; ceramic; polymers, such as polycarbonate, polyurethane, polyethylene, polyvinyl chloride, and other polymers and polymer blends; graphite fiber and graphite fiber composites; fiberglass; hybrid materials including metal fibers and plastic or polymer; and other materials. For example, a case may be made from polycarbonate.

A solar powered charger in one embodiment of the invention may include any suitable clip or connector effective to attach or affix the charger to another object. Any clip, clasp, ring, clamp, or other connector, including, for example a Velcro® holder, may be used. In preferred embodiments, a clip may be a carabiner clip. A carabiner includes a hinge, a spring, a clasp, and a passage therethrough. Clips having features of the invention are configured to support up to about 10 kilograms, or about 20 kilograms, or about 30 kilograms of force without breaking. For example, in embodiments of solar powered chargers having features of the invention, a clip may be designed to, and be effective to, withstand and support weight in excess of 100 kg; or in excess of 200 kg; or more.

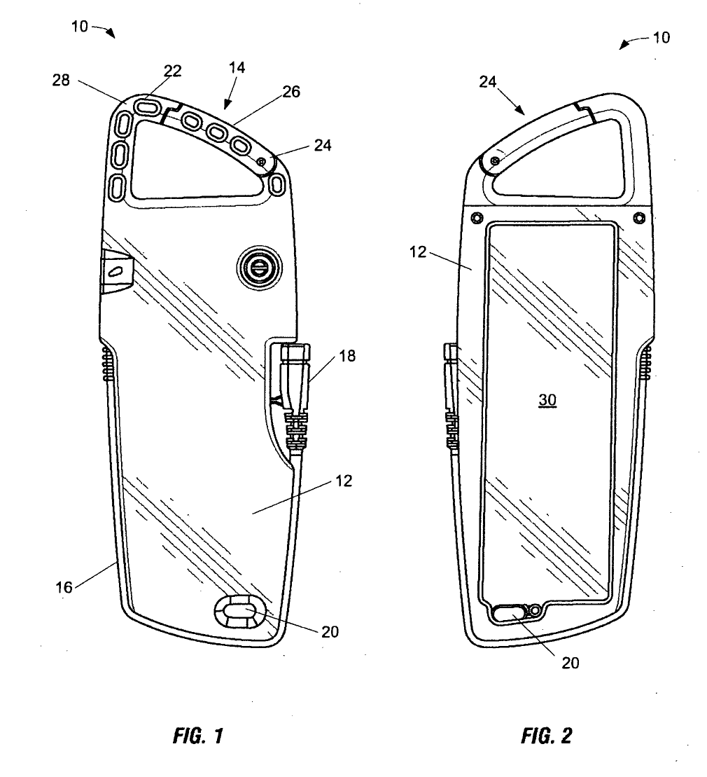

As illustrated in FIG. 1, solar-powered charger 10 having features of the invention, showing a sturdy case 12 embodying a carabiner clip 14 at a top end portion, a flexible electrical cable 16 with connector 18, and a pass-through 20 at a bottom end portion. In the embodiment shown, portions 22 of the carabiner clip 14 are indented to provide reduced weight and enhanced strength. Carabiner clip 14 includes a hinge 24, a clip portion 26 and a clasp portion 28.

FIG. 2 is a plan view of a solar-powered charger 10 having features of the invention, showing a sturdy case 12 having a carabiner clip 14 at a top end portion of the case 12, the carabiner clip 14 having includes a hinge 24, a clip portion 26 and a clasp portion 28. A solar-powered charger 10 having features of the invention also has a solar collector surface 30 and a pass-through 20 at a bottom end portion.

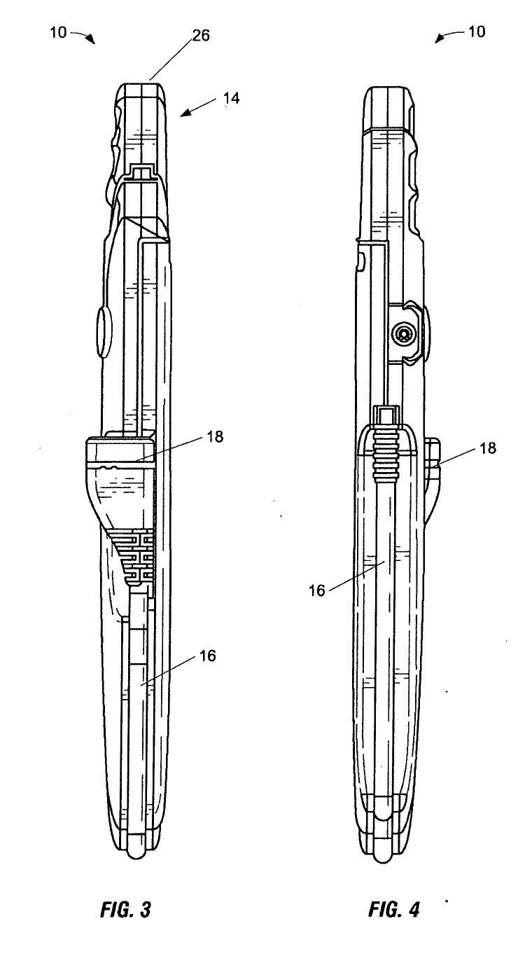

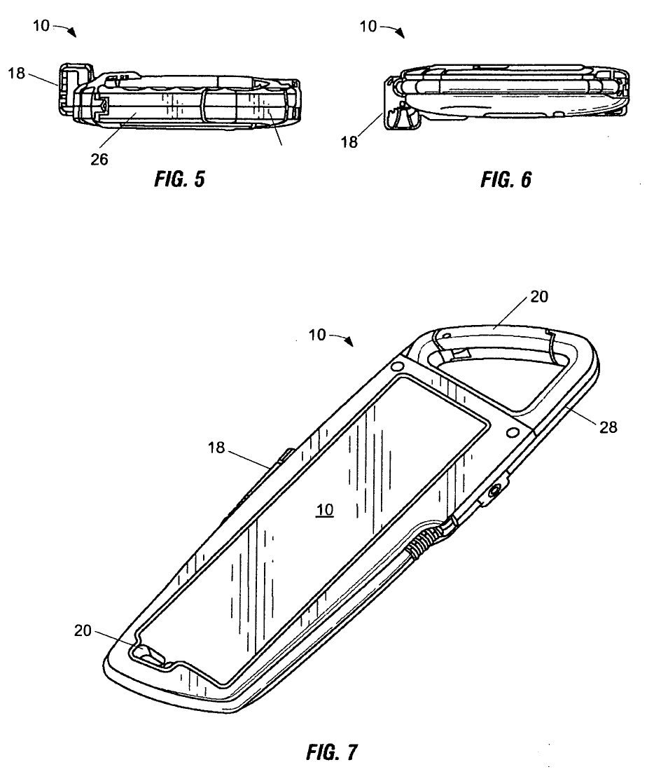

FIGS. 3 and 4 provide side views of the solar powered charger shown in FIGS. 1 and 2. A plug 32 is shown in FIG. 4. FIGS. 5 and 6 provide perspective views of the solar powered charger shown in FIGS. 1 and 2.

FIG. 7 is a perspective view of a solar powered charger having features of the invention, showing a sturdy casing 12, a carabiner clip 14 at a top portion of the casing 12, a solar collector surface 30, and a pass-through 20 at a bottom end portion of the charger 10.

Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A solar-powered charger, comprising:
a solar collector configured to generate electrical energy when exposed to light;
a battery coupled to the solar collector configured to receive and store the electrical energy;
a connector coupled to the solar collector and the battery to provide a pathway for discharging the electrical energy to an external device; and
a casing configured to retain the solar collector, the battery and the connector, comprising an integral clip configured to attach the solar-power charger to a plurality of objects.

2. The solar-powered charger of claim 1, wherein the integral clip comprises a carabiner clip.

3. The solar-powered charger of claim 1, wherein the integral clip comprises a Velcro® clasp.

4. The solar-powered charger of claim 1, wherein the casing comprises one of a metal casing, a ceramic casing, a plastic casing and a composite casing.

5. The solar-powered charger of claim 4, wherein the metal casing comprises one of a magnesium casing, an aluminum casing, a steel casing and a stainless steel casing.

6. The solar-powered charger of claim 4, wherein the plastic casing comprises one of a polycarbonate casing, a polyurethane casing, a polyethylene casing, a polyvinyl chloride casing and polymer blends.

7. The solar-powered charger of claim 4, wherein the composite casing comprises one of a graphite fiber composite casing, a fiberglass casing and a composite metal and plastic casing.

8. The solar-powered charger of claim 1, wherein the battery comprises one of a nickel-cadmium rechargeable battery and a lithium-ion rechargeable battery.

9. The solar-powered charger of claim 1, further comprising a control and switching network configured to switch the solar collector and the battery between a serial connection and a parallel connection.

10. The solar-powered charger of claim 1, wherein the connector is configured to provide an adaptable interface to a plurality of interfaces including a USB interface.

11. The solar-powered charger of claim 1, wherein the solar collector comprises one of a selenium metal photoelectric element, a silicon semiconductor photoelectric element, an amorphous silicon photoelectric element, an amorphous-microcrystalline silicon stacked photoelectric element, a crystalline silicon photoelectric element, a polycrystalline silicon photoelectric element, a copper indium selenide photoelectric element and a compound semiconductor photoelectric element.

12. The solar-powered charger of claim 1, wherein the solar collector is encapsulated in one of a transparent plastic material, a transparent polymer material and a transparent ceramic material to render the solar collector waterproof and gas-impermeable.
